(19) United States
(12) Patent Application Publication
(10) Pub. No.: US 2020/0221739 A1
(43) Pub. Date: Jul. 16, 2020

(54) METHOD FOR REMOVAL OF ANTIBIOTIC RESIDUES FROM FOOD PRODUCTS

(71) Applicant: The King Abdulaziz City for Science and Technology, Riyadh (SA)

(72) Inventor: Omar Ahmed Alsager, Riyadh (SA)

(73) Assignee: The King Abdulaziz City for Science and Technology, Riyadh (SA)

(21) Appl. No.: 15/083,254

(22) Filed: Mar. 28, 2016

(51) Int. Cl. A23L 3/26

(52) U.S. Cl. CPC A23L 3/263

(57) ABSTRACT

The invention provides a method for removal of antibiotic residues from food products by irradiating the food product with a dose of ionizing gamma radiation for an effective duration of time. The food product undergoing irradiation by ionizing gamma radiation is selected from a group of dairy and poultry products and its likes thereof.

### FIELD OF THE INVENTION

The invention generally relates to removal of antibiotic residues from food products. More specifically, the invention relates to removal of antibiotic residues from dairy and poultry products by irradiating ionizing gamma radiation.

### BACKGROUND OF THE INVENTION

Extensive use of antibiotics in veterinary medicine and animal derived food products for disease treatment, prophylaxis, growth promotion and especially for increasing the production of food products such as milk, eggs, meat, etc. has been observed over the years.

Subjection to antibiotics and its discharge has greatly altered the microbial ecosystems of humans, animals and the environment leading to development of antimicrobial resistance towards the antibiotics widely present in the environment. The multiple survival methods of microbes involving antimicrobial resistance includes, but not limited to, decreased uptake, increased efflux of an antibiotic, alteration of binding site topography.

The entry of significant amount of antibiotic residues into the human microbial ecosystem through the animal derived food products induces immunological responses in susceptible individuals and causes disorders in the intestinal flora. Dairy and Poultry consuming countries including developed and developing countries across the globe have identified elevated levels of certain antibiotics (levels exceeding the MRLs (maximum residual limit)). There is need for a process to eliminate antibiotic residues or to control it within the permissible levels of MRLs.

Yet again, economic loss is a huge concern in the milk production industry owing to the antibiotic residues present in milk thereby leading to the discarding and disposal of milk and again effectively reaching the environmental ecosystem. Recycling of milk by feeding the waste milk to calves' builds up antibiotic resistance and microbial contamination such as, but not limited to, E. coli, and bovine viral diarrhea virus.

The erstwhile method and processes involved in removal of antibiotic residues from aqueous media largely involves physical, biological and chemical methods. The physical and biological methods typically include filtration, coagulation, flocculation, and sedimentation have proven to be inefficient in elimination of antibiotic residues in food products. Advanced microfiltration/reverse osmosis technology coupled with UV radiation also cannot eliminate antibiotic residues from wastewater.

Additionally, advanced oxidation processes (AOPs) although considered a highly efficient method in the removal of various organic residues in aqueous media including antibiotics residues, the degradation process occurs by formation of hydroxyl radicals which are highly reactive and non-selective.

Therefore, there is a need for an improved and economically viable method for elimination of antibiotic residues from food products especially dairy and poultry products.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a flow diagram enumerating the steps involved in the method of irradiating food products by a dose of gamma radiation in accordance with an embodiment of the present invention.

FIG. 2A illustrates systematic degradation of doxycycline of different concentrations (1 |iM to 50 |iM) under different gamma radiation doses (0.5-7 kGy) and FIG. 2B illustrates Uv-Vis spectra of the degradation of 50 |iM doxycycline under different gamma radiation doses.

FIG. 3A illustrates systematic degradation of amoxicillin of different concentrations (1 |iM to 50 |iM) under different gamma radiation doses (0.5-7 kGy) and FIG. 3B illustrates a Uv-Vis spectra of the degradation of 50 |iM amoxicillin under different gamma radiation doses.

FIG. 4A illustrates a systematic degradation of ciprofloxacin of different concentrations (1 |iM to 50 |iM) under different gamma radiation doses (0.5-7 kGy). And FIG. 4B illustrates a Uv-Vis spectra of the degradation of 50 |iM ciprofloxacin under different gamma radiation doses.

FIG. 5 illustrates a comparison of HPLC signals of a range of amoxicillin concentration before and after irradiation at a dose rate of 7 kGy. The concentrations of amoxicillin after irradiation with 7 kGy were below the detection limit of HPLC and were set to zero.

FIG. 6 illustrates an HPLC analysis of extracted samples from spiked amoxicillin in milk.

FIG. 7 illustrates an HPLC analysis of extracted samples of amoxicillin spiked in eggs.

FIG. 8 illustrates an HPLC analysis of extracted samples of amoxicillin spiked in chicken meat.

FIG. 9 illustrates removal percentages of amoxicillin in different matrixes, the percentages being calculated on comparing a given concentration before and after irradiation.

FIG. 10A illustrates ¹H NMR spectra of 5 mg/mL amoxicillin before irradiation at a dose rate of 7 kGy.

FIG. 10B illustrates ¹H NMR spectra of 5 mg/mL amoxicillin after (B) irradiation at a dose rate of 7 kGy.

FIG. 11A illustrates ¹³C spectra of 5 mg/mL amoxicillin before irradiation at a dose rate of 7 kGy.

FIG. 11B illustrates ¹³C spectra of 5 mg/mL amoxicillin after irradiation at a dose rate of 7 kGy.

FIG. 12A illustrates bacterial growth inhibition experiments with control experiments conducted with un-irradiated water.

FIG. 12B illustrates bacterial growth inhibition experiments with control experiments conducted with irradiated water.

### DETAILED DESCRIPTION OF THE INVENTION

Before describing in detail embodiments that are in accordance with the present invention, it should be observed that the embodiments reside primarily in combinations of method steps related to removal of antibiotic residues by irradiating ionizing gamma radiation. Accordingly, the method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In the present disclosure, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide a method for removal of antibiotic residue from a food product, wherein the food product is selected from a group of dairy and poultry products. In accordance with the invention, the irradiating of the food product occurs at a dose of ionizing gamma radiation. The dose of ionizing gamma radiation falls within the recommended irradiation doses for food products by the International Atomic Energy Agency (IAEA).

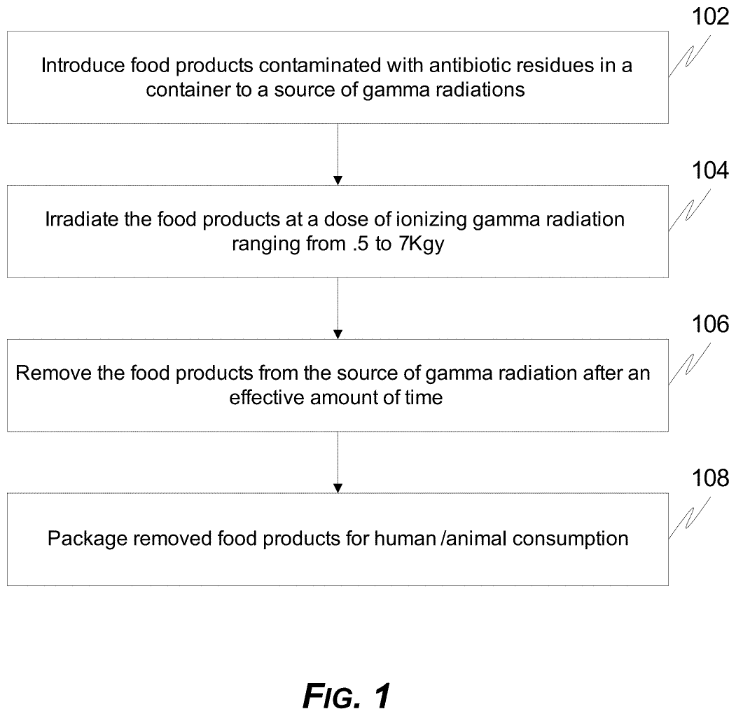

FIG. 1 illustrates a flow diagram enumerating the steps involved in the method of irradiating food products by a dose of gamma radiation in accordance with an embodiment of the present invention. The food products are selected from a group of dairy and poultry products. The dairy products further include milk, milk derivatives and their likes thereof. The poultry products further include eggs, chicken meat and other poultry derivatives.

Considering the method of removal of antibiotic residues is from dairy and poultry products, the food products may be veterinary antibiotics. The antibiotic residues found in the dairy and poultry products wherein the antibiotics residues are not limited to, but include P-Lactam antibiotics (penicillin and its derivatives), tetracycline and its derivatives, chloramphenicol and its derivatives, cephalosporin and its derivatives, and azithromycin and its derivatives and its likes thereof.

The antibiotic decomposition is based on an oxidation reaction that takes place between hydroxyl radicals (OH*), produced in situ during water radiolysis by gamma radiation and the antibiotic residues in the food products. Hydroxyl radicals are strong oxidizing species with the ability to break down complex organic molecule like antibiotics into simpler and less toxic radiolytic fragments through chain oxidation reactions.

In accordance with FIG. 1, the food products are introduced to a gamma radiation source in containers at step 102. A material of the container can be selected from a group of metal, plastic, paper and glass. The ionizing gamma radiation is sourced from Cobalt-60 gamma rays.

In accordance with an exemplary embodiment of the invention, the irradiation of the food products occurs for an effective amount of time at step 104. The effective amount of time is defined based on the radioactivity of the source providing the ionizing gamma radiation to the food products. In an embodiment, the method of irradiating ionizing gamma radiation on food products involves a dose rate of 4.177 kGy the dose rate being defined as the quantity of gamma radiation absorbed per unit time. Further, the method of irradiating ionizing gamma radiation on food products involves a transit dose of 5.39 Gy s⁻¹.

Thereafter, at step 106, the irradiated food products are removed from the source after irradiating occurs for the effective amount of time. Lastly, at step 108, the irradiated products may be packaged for human or animal consumption.

The procedures and advantages of the present invention are illustrated in the following representative examples. However, it is understood that the present invention is not limited to these examples and that any modification and correction can be accomplished within the technical scope of the present invention.

### EXAMPLES

In the foregoing examples, irradiation of ionizing gamma radiation was carried out in double distilled water followed by irradiation of ionizing gamma radiation of spiked samples of milk, egg and meat. Examples of suitable antibiotics administered are amoxicillin, doxycycline and ciprofloxacin of analytical grades to represent the commonly used broad-spectrum antimicrobial in veterinary medicine. The antibiotic concentrations in both aqueous solutions (double distilled water) and spiked dairy and poultry products were chosen to fall within the recommended maximum residues limit (MRLs) by the international organizations (such as European Union).

In all the example mentioned in the foregoing, the source of gamma radiation is a Cobalt-60 gamma rays source model Gamma Cell 220 from MDS Nordion, Canada. The source of gamma radiation was calibrated using aqueous ferrous sulfate (Fricke dosimetry) solution.

### Example 1

The three target antibiotics as mentioned above were dissolved in double distilled water to make desired concentrations (in 10 mL volume). Different concentrations of antibiotics (1 |iM to 50 |iM) were irradiated with different doses of 0.5, 1, 2, 5, and 7 kGy of ionizing gamma radiation (0.5 to 7 kGy). This particular range of concentration was selected because the recommended maximum residual limit of the experimented antibiotics in foods fall within this range. UV-Vis absorption spectra of the studied antibiotics in solution were recorded before and after irradiation treatment at different doses. Experiments were conducted in double distilled water to optimize the irradiation dose for further experiments in spiked dairy and poultry products.

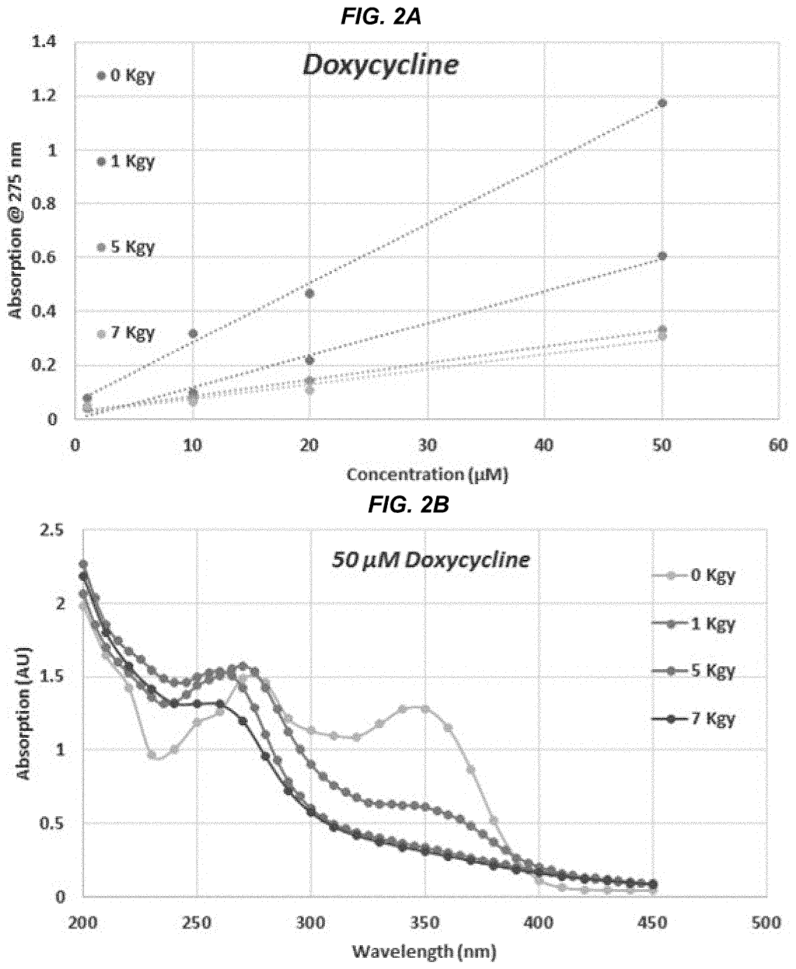

With reference to FIG. 2A, the maximum absorption of doxycycline at 275 nm was plotted against the concentration. A gradual decrease in the absorption of doxycycline at 275 nm across the studied range of concentrations was observed as a result of the exposure to increasing irradiation doses. With reference to FIG. 2B, Uv-Vis spectra representing the behavior of 50 |iM doxycycline upon exposure to increasing irradiation does form 0.5 kGy to 7 kGy was observed. The decreasing trend in the intensity of maximum absorption peaks at 275 nm and 350 nm is indicative of decomposition and complete removal based associated with the highest applied radiation dose at 7 kGy with no further decrease in the absorption bands when 10 kGy was applied.

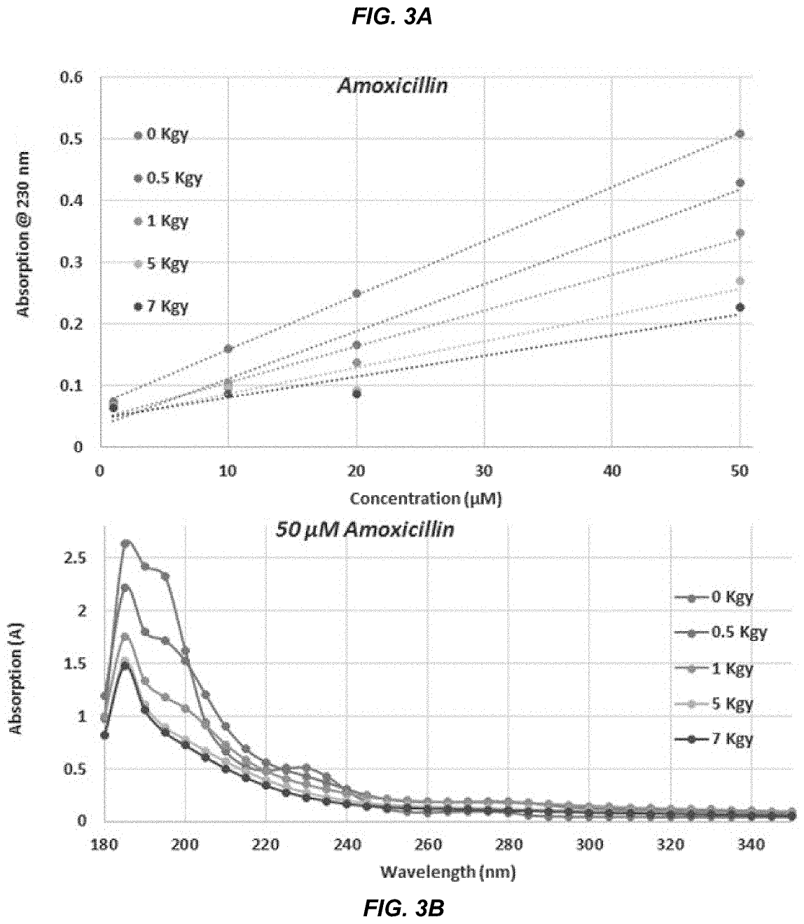

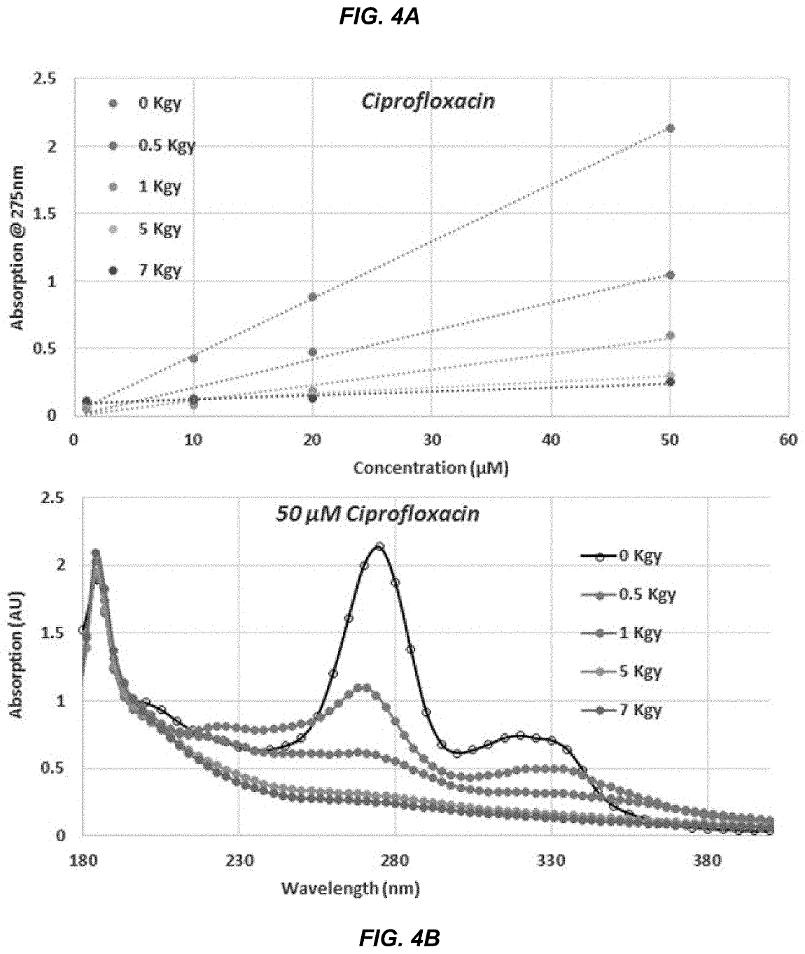

With reference to FIG. 3A and FIG. 4A, systematic investigation of the behavior of amoxicillin and ciprofloxacin under various irradiation doses is observed. Significant reduction in the concentration of amoxicillin and ciprofloxacin upon increasing the irradiation does from 0.5 kGy to 7 kGy is observed. Additionally, FIG. 3B and FIG. 4B shows that at 50 |iM, amoxicillin and ciprofloxacin are completely removed. Thus, 7 kGy was selected for further irradiation experiments in spiked dairy and poultry products.

### Example 2

The desired concentration of amoxicillin was spiked in water, milk, eggs, and chicken meat. 20 |iL of spiked water samples before and post irradiation treatment was directly injected in HPLC. Amoxicillin spiked in milk, eggs, and chicken meat was extracted using acetonitrile. 2 mL (milk or eggs) or 2 g (chicken meat) of the spiked samples was mixed with 5 mL acetonitrile and shaken for 10 minutes following which the samples were centrifuged for 5 minutes at a speed of 3000 rpm. 5 mL of the supernatant was evaporated in a rotary-evaporation system and the antibiotic residue was dissolved in 2 mL of double distilled water. 20 |iL of the extracted samples was injected in HPLC.

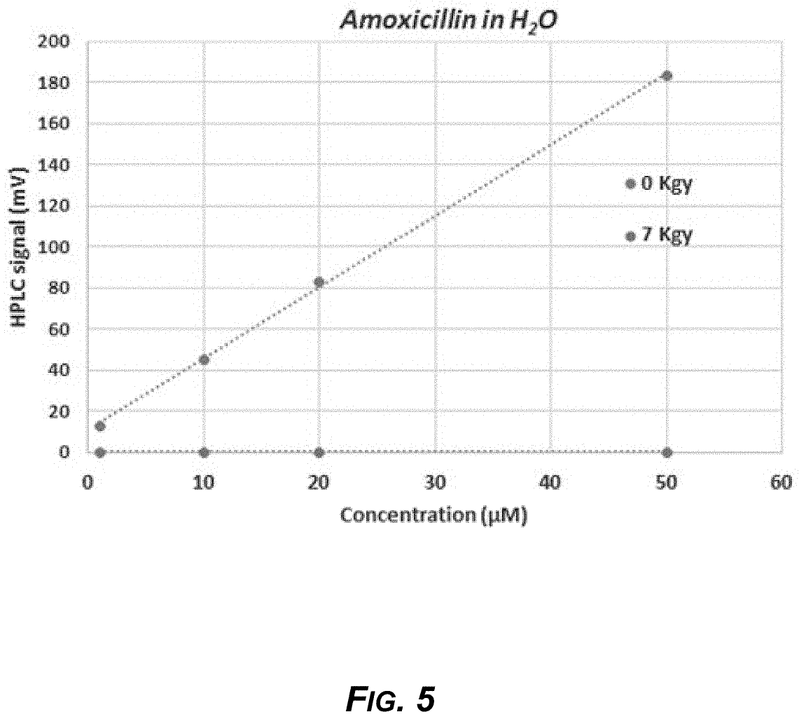

Direct Uv-Vis measurements cannot be conducted to quantify the antibiotics in samples extracted from dairy or poultry products due to the significant chemical interference. FIG. 5 illustrates a comparison of HPLC signals of a range of amoxicillin concentration before and after irradiation with 7 kGy. The concentrations of amoxicillin after irradiation with 7 kGy were below the detection limit of HPLC and were set to zero.

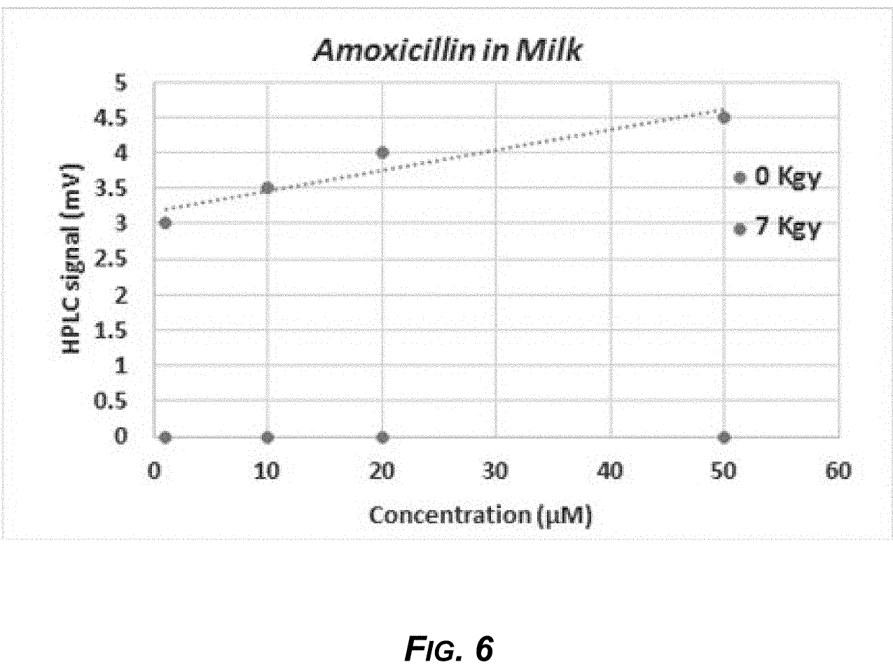

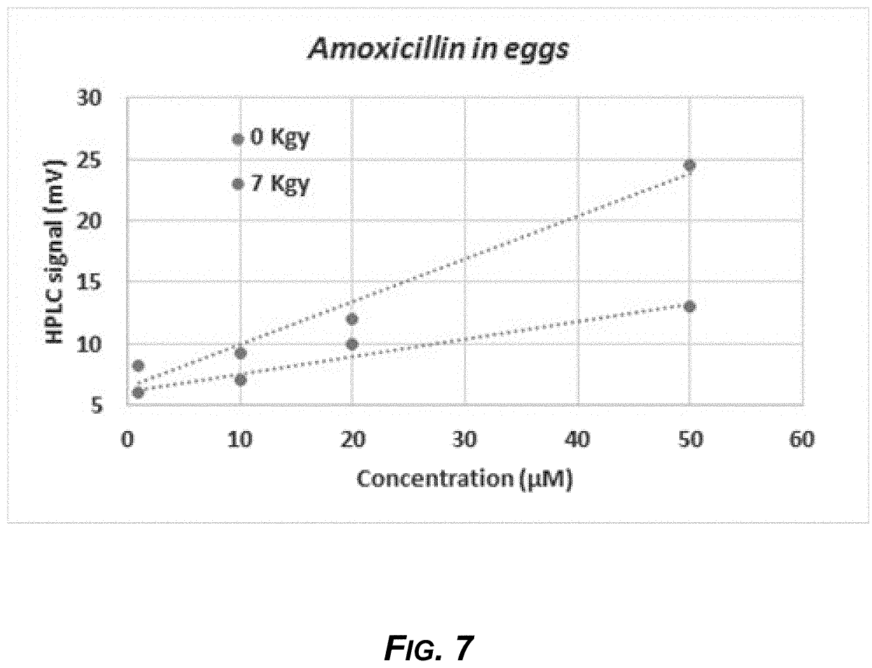

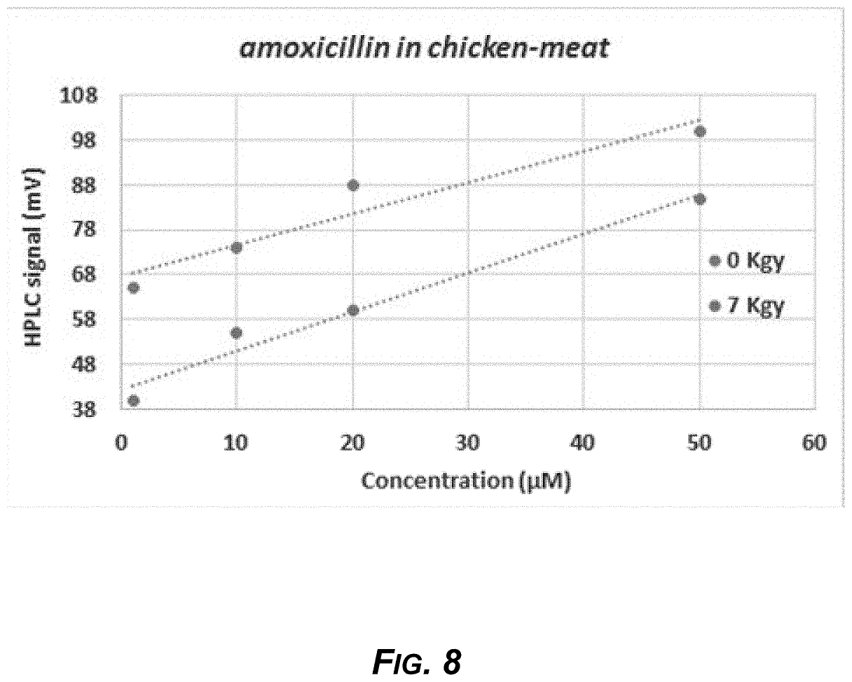

FIG. 6 is illustrative of amoxicillin being removed from spiked milk samples on being irradiated with an irradiation dose of 7 kGy. FIG. 7 and FIG. 8 represent a comparison between the concentrations of amoxicillin spiked in eggs and chicken meat samples, respectively, before and after irradiation. A significant reduction in spiked amoxicillin concentrations in eggs and chicken samples upon irradiation with 7 kGy.

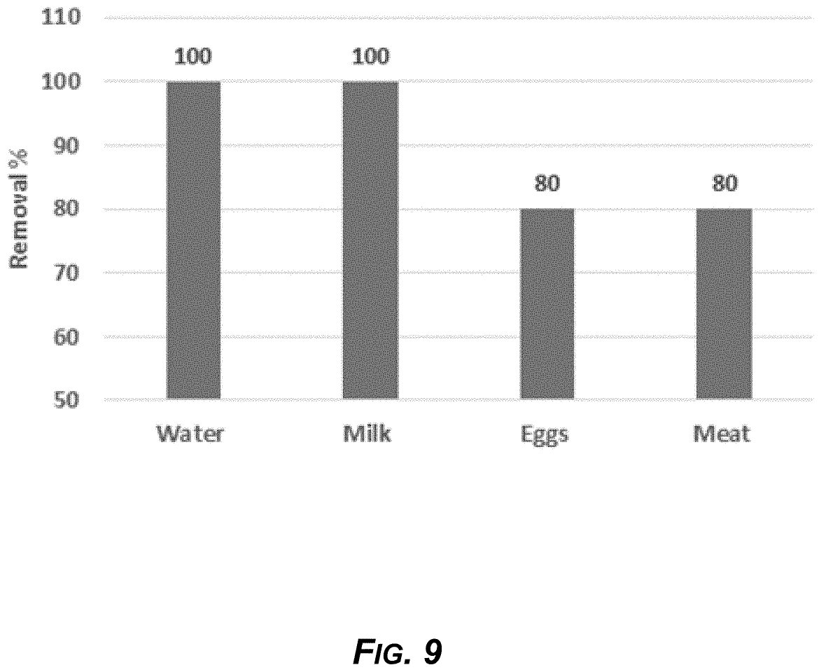

Removal percentage of amoxicillin in different samples with varied concentrations is reported by comparing the original concentrations with the corresponding post irradiation concentrations (i.e. before and after irradiation). FIG. 9 illustrates the average removal percentages for each sample type across the different concentration range (1, 10, 20, and 50 |iM), assuming 15% error in the observations. It was observed that there was 100% removal and decomposition of amoxicillin in water & milk samples and 80% removal of amoxicillin in eggs & chicken meat samples at a radiation dose of 7 kGy, within the permissible limits accepted by IAEA for food irradiation.

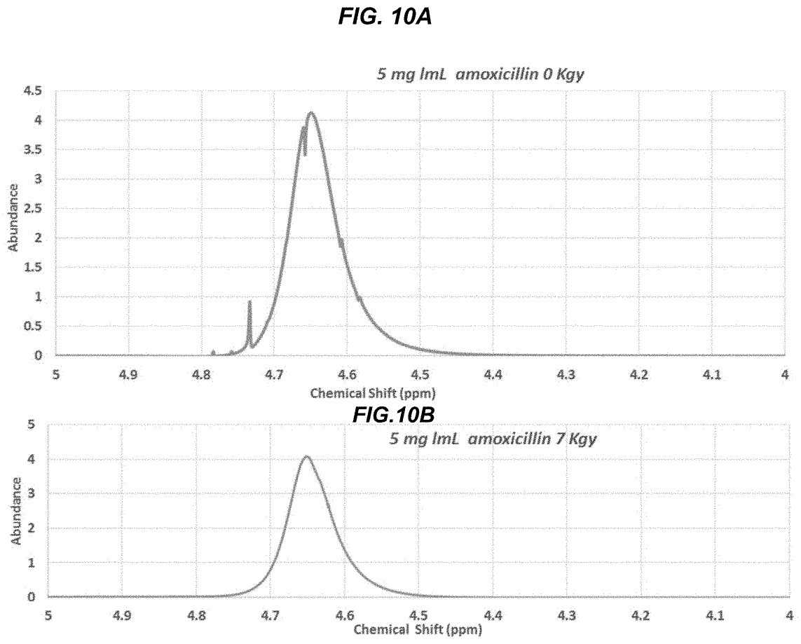

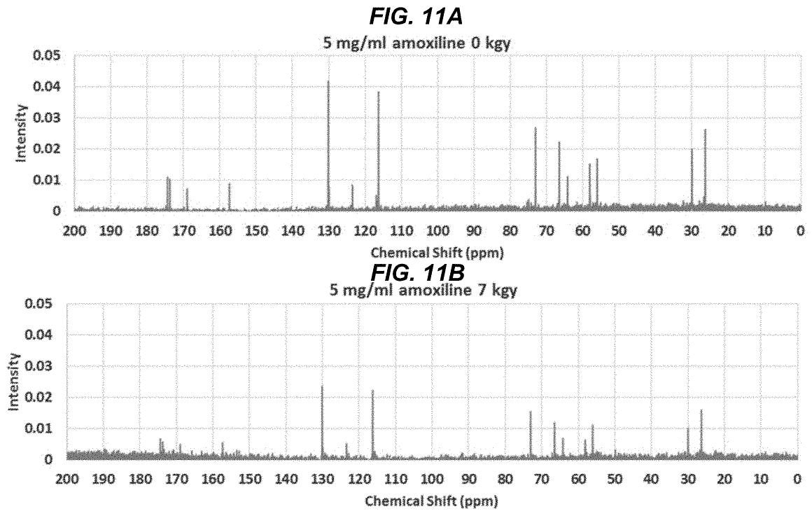

Further, an additional confirmation of the degradation of amoxicillin was conducted using ¹H and ¹³C NMR studies. Amoxicillin is dissolved in water and diluted at a ratio of 1:1 using D2O. A high concentration of amoxicillin (5 mg/mL) was used for this technique, with water as the NMR solvent. FIG. 10B shows ¹H NMR spectrum of irradiated amoxicillin at 7 kGy compared to a control represented by FIG. 10A. It is observed that the proton signals (at 4.5 to 4.8 ppm) of amoxicillin before irradiation are disappearing upon irradiation treatment. FIG. 11 illustrates the ¹³C spectra of 5 mg/mL amoxicillin before and after irradiation treatment at 7 kGy for amoxicillin. Overall, the intensities of ¹³C peaks are reduced (approximately 50%) after irradiation treatment indicating the decomposition and reduction in amoxicillin concentration in the sample.

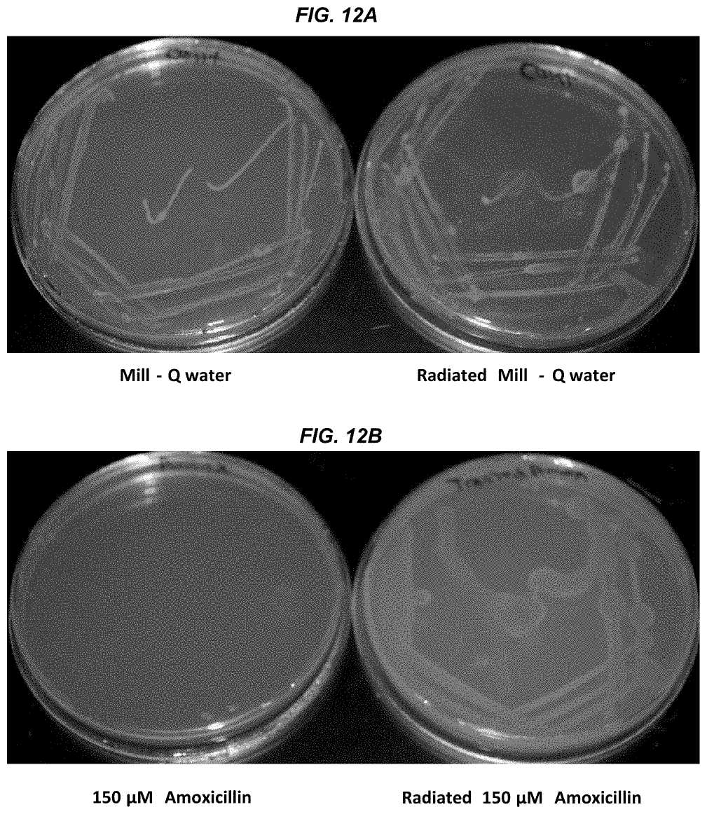

In addition, the potential of antimicrobial activity of the irradiation decomposition by-product using E-coli growth inhibition experiments, which is known to be susceptible to amoxicillin was conducted. With reference to FIG. 12 (top panel), two control experiments with water were conducted. Irradiating amoxicillin at a concentration of 150 |iM and at an irradiation dose of 7 kGy illustrates complete loss of antimicrobial effect of the sample. This was indicated from E-coli growth shown with the radiated amoxicillin sample in comparison to the growth inhibition associated with the non-irradiated amoxicillin sample. The example hereby confirms that the removal by-products advantageously do not show antimicrobial activity thereby indicative of the elimination of antibiotic residues.

Those skilled in the art will realize that the above recognized advantages and other advantages described herein are merely exemplary and are not meant to be a complete rendering of all of the advantages of the various embodiments of the present invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. A method for elimination of antibiotic residue from a food product, wherein the food product is selected from a group of dairy and poultry products, the dairy and poultry products contaminated with antibiotic residues, the method comprising:
irradiating the food product with a dose of ionizing gamma radiation, the dose of ionizing gamma radiation ranging from 0.5 to 7 kGy.

2. The method as claimed in claim 1, wherein irradiating with ionizing gamma radiation comprises ionizing gamma radiation sourced from Cobalt-60 gamma rays.

3. The method as claimed in claim 1, wherein irradiating with ionizing gamma radiation comprises ionizing gamma radiation sourced from Caesium-137 gamma rays.

4. The method as claimed in claim 1, wherein irradiating of ionizing gamma radiation occurs at a dose rate of 4.177 kGy h⁻¹.

5. The method as claimed in claim 1, wherein irradiating of ionizing gamma radiation occurs at a transit dose of 5.39 Gy s⁻¹.

6. The method as claimed in claim 1, wherein the dairy and poultry products are contaminated with veterinary antibiotics.

7. The method as claimed in claim 1, wherein the dairy and poultry products are contaminated with an antibiotic selected from a group of β-Lactam antibiotics and its derivatives, tetracycline and its derivatives, chloramphenicol and its derivatives, cephalosporin and its derivatives, and azithromycin and its derivatives and the likes or mixtures thereof.

8. The method as claimed in claim 1, wherein the dairy products include milk and milk derivatives.

9. The method as claimed in claim 1, wherein the poultry products include eggs, meat and poultry derivatives.
